(19) United States
(12) Patent Application Publication
(10) Pub. No.: US 2017/0228538 A1
(43) Pub. Date: Aug. 10, 2017

(54) SAFETY DETERMINING APPARATUS AND METHOD

(71) Applicant: FUJITSU LIMITED, Kawasaki-shi, (JP)

(72) Inventors: Yoshinori Katayama, Kawasaki (JP); Takeaki Terada, Kawasaki (JP); Satoru Torii, Yokohama (JP); Hiroshi Tsuda, Fujisawa (JP)

(73) Assignee: FUJITSU LIMITED, Kawasaki-shi (JP)

(21) Appl. No.: 15/410,052

(22) Filed: Jan. 19, 2017

(30) Foreign Application Priority Data
Feb. 4, 2016 (JP) 2016-020299

(51) Int. Cl. G06F 21/55

(52) U.S. Cl. CPC G06F 21/554; G06F 2221/032

(57) ABSTRACT

A safety determining apparatus includes a memory and a processor coupled to the memory. The processor is configured to acquire information on a user operation and an access target of the user operation, acquire information indicating a behavior of refraining from gaining access with respect to the access target by analyzing the user operation, and provide a user with information on the safety of the access target with respect to which the behavior has been executed.

### CROSS-REFERENCE TO RELATED APPLICATION

This application is based upon and claims the benefit of priority of the prior Japanese Patent Application No. 2016-020299, filed on Feb. 4, 2016, the entire contents of which are incorporated herein by reference.

### FIELD

A certain aspect of the embodiment discussed herein is related to safety determining apparatuses and methods.

### BACKGROUND

Cyber-attacks that cause harm such as computer virus infection by causing a user to select a uniform resource locator (URL) link embedded in electronic mail (email) text to draw the user to an illicit website or by causing a user to open a malicious file attachment (attached file) are on the increase.

Conventional techniques include access safety determination using a blacklist (in which suspicious entities are registered in advance) or a whitelist (in which safe entities are registered in advance), and a reputation function. The reputation function provides assessments of access targets (see, for example, Japanese National Publication of International Patent Application No. 2011-527046), and is used in services that pro-actively deliver information on the behaviors of other users who have behaved in a similar manner with respect to purchasing behaviors or search behaviors on the Internet. These techniques use the information of users who have actually accessed entities.

Furthermore, techniques regarding email security measures have been proposed (see, for example, Japanese Laid-open Patent Publication No. 2006-270504, International Publication Pamphlet No. WO 2014/087597, and Japanese Laid-open Patent Publication No. 2013-137745).

### SUMMARY

According to an aspect of the invention, a safety determining apparatus includes a memory and a processor coupled to the memory. The processor is configured to acquire information on a user operation and an access target of the user operation, acquire information indicating a behavior of refraining from gaining access with respect to the access target by analyzing the user operation, and provide a user with information on the safety of the access target with respect to which the behavior has been executed.

The object and advantages of the embodiment will be realized and attained by means of the elements and combinations particularly pointed out in the claims.

It is to be understood that both the foregoing general description and the following detailed description are exemplary and explanatory and not restrictive of the invention.

### BRIEF DESCRIPTION OF THE DRAWINGS

FIG. 1 is a diagram depicting a system configuration according to an embodiment;

FIG. 2 is a diagram depicting a functional configuration pertaining to information gathering;

FIG. 3 is a diagram depicting a functional configuration pertaining to provision of information;

FIGS. 4A through 4D are diagrams depicting various types of information;

FIG. 5 is a diagram depicting a hardware configuration of a terminal and the server;

FIG. 6 is a flowchart illustrating an example of the detection of a cancellation behavior;

FIG. 7 is a flowchart illustrating another example of the detection of a cancellation behavior;

FIG. 8 is a flowchart illustrating a process of analyzing a cancellation behavior;

FIG. 9 is a flowchart illustrating a process of alerting;

FIG. 10 is a diagram illustrating an example of alerting; and

FIG. 11 is a diagram illustrating provision of information.

### DESCRIPTION OF EMBODIMENTS

As described above, the conventional techniques are based on the determination of the safety of access targets using the information of users who have actually accessed entities, and therefore have the problem of inability to determine the safety of new URL links or file attachments that have not been actually accessed by any user. That is, with respect to new or non-accessed URLs having no registered information, it is not possible to perform determination based on registered information. Therefore, other user-related information, such as domain information or other related search information, is examined in detail to make a determination, or access is simply avoided. Thus, it is difficult to properly maintain network security.

Therefore, according to an aspect, the disclosure has an object of improving network security.

One or more preferred embodiments of the present invention will be explained with reference to accompanying drawings.

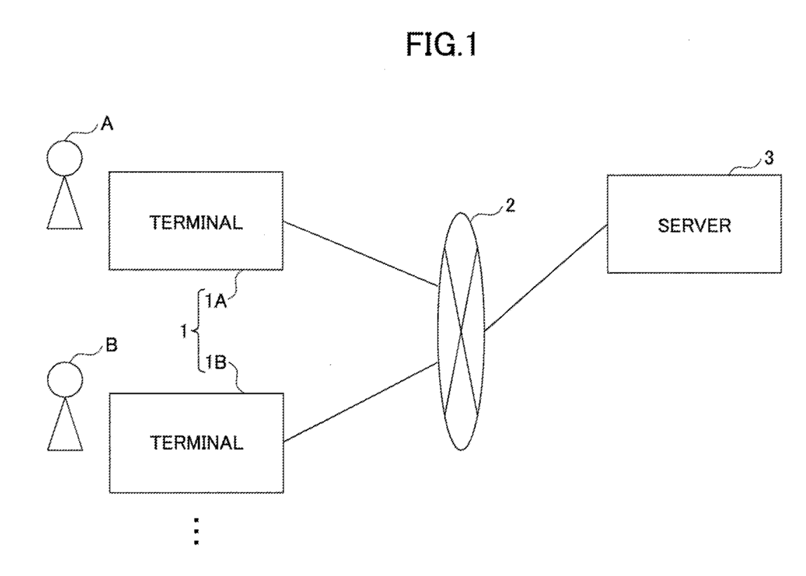

FIG. 1 is a diagram depicting a configuration of a system according to an embodiment. Referring to FIG. 1, terminal apparatuses (personal computer [PC] clients) including terminal apparatuses 1A and 1B (hereinafter collectively referred to as “terminal 1” where a description is common to the terminal apparatuses 1A and 1B) are connected to a network 2 such as the Internet, and a server apparatus 3 (“server 3”) that manages information related to network security is connected to the network 2. It is assumed that the terminal 1A is used by User A and the terminal 1B is used by User B.

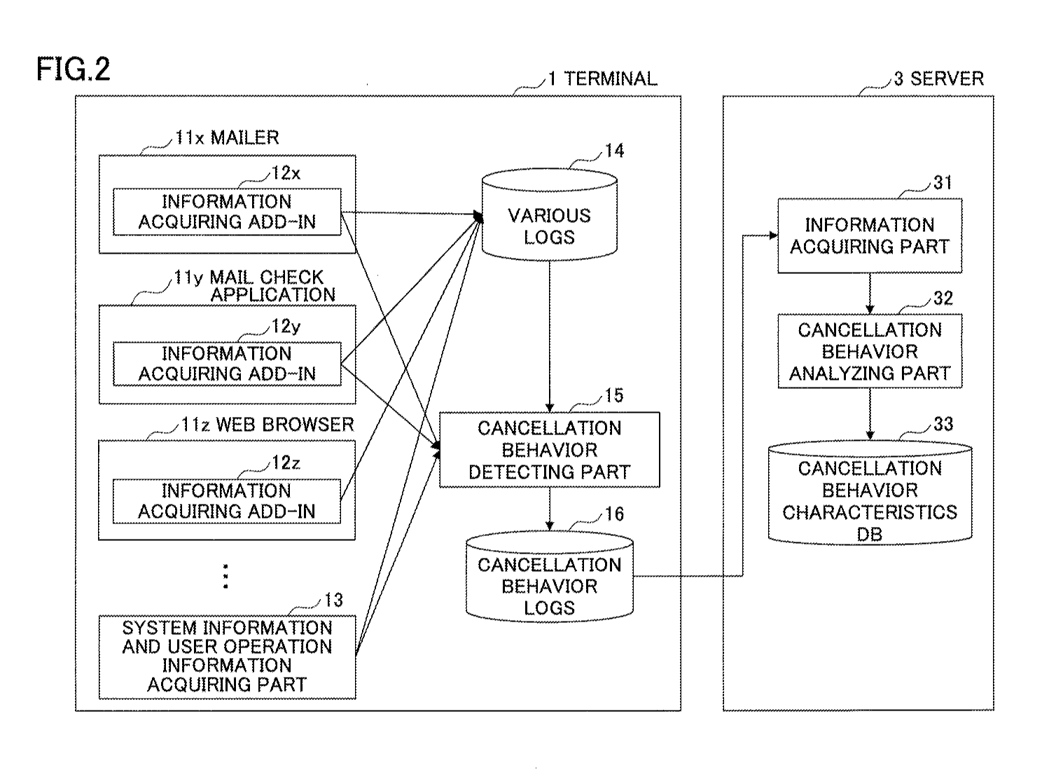

FIG. 2 is a diagram depicting a functional configuration pertaining to information gathering.

Referring to FIG. 2, the terminal 1 includes application programs such as a mailer 11x, a mail check application 11y, and a web browser 11z, and information acquiring add-ins that acquire information in application programs, such as information acquiring add-ins 12x, 12y, and 12z that acquire information in the mailer 11x, the mail check application 11y, and the web browser 11z, respectively. The mailer 11x is an application program that transmits and receives email. The mail check application 11y is an application program that checks email transmitted or received by the mailer 11x. The web browser 11z is an application program that accesses websites. When a URL link embedded in the text of email is selected (clicked) in the mailer 11x, the website specified by the URL is accessed via the web browser 11z. Although not depicted, information acquiring add-ins are likewise provided in application programs used to open file attachments, such as a word processing application, a spreadsheet application, and a presentation application.

Furthermore, the terminal 1 includes a system information and user operation information acquiring part 13 that acquires system information and user operation information from, for example, the operating system (OS) of the terminal 1.

Information acquired by the information acquiring add-ins such as the information acquiring add-ins 12x, 12y, and 12z and information acquired by the system information and user operation information acquiring part 13 are chronologically retained in various logs 14.

The mode of acquiring the user operation information, which is switched to a mode of acquiring detailed operation logs (in particular, mouse operation logs) when the content that is an object of operation includes an access target, is normally set to a mode of only acquiring mouse clicking operations at regular intervals, thereby trying to prevent an increase in the log size and an increase in the operational load as much as possible.

Information acquired from the mailer 11x includes the following:

[Inbound Log (one record is output when doing a policy check on received email)]

Application version number

Policy version number

Message ID

What number message among those received

Whether From Domain is in a domain list

From Domain

Sender Domain

Reply-To Domain

Return-Path Domain

To Domain

Cc Domain

Domain in Received

Timezone in Received

Whether an IP address other than a local IP address is included in the Received header

IP address in the Received header

Date

X-Mailer

User-Agent

X-Spam-FJ

Content-Type

Default rule check result

Default rule non-matching factor

Default rule matching factor

Filter matching factor

Presence or absence of MAC

MAC verification result

Initial reception (presence or absence of a sender learning list)

Learning check result

Factor subject to a learning check

Whether to display a reception confirmation screen

Reception confirmation screen display start time

Number of times all warning messages are checked

(Number of times all buttons become depressible)

a time at which all warning messages are checked

Reception confirmation screen display end time

Reception confirmation screen selection button

Sender address

Initial reception (presence or absence of an inbound whitelist)

Sender position (title) code

Email size

Number of characters of email text

Email reception date and time

Policy check start time

Policy check end time

[Email Content Log (one record is output when doing a policy check on received email)]

Message ID in the header of received email

Date and time of reception of email from a mail server

Item type (a file attachment or a URL link)

URL domain name in the case where the item type is a URL link

Item name

Item size (−1 in the case of a URL link)

From Domain name of email containing a content

Substance of an operation on an item (CHECK when doing a policy check on received email, BAD OPEN when an attempt to open an item is made before confirming safety, OPEN when an attempt to open an item is made after confirming safety, PREVIEW when doing a preview after confirming safety, and READ when viewing email from Outlook.

[Email Header Log (one record is output when doing a policy check on received email. This log is a binary file.)]

Record length of one record

Message ID of received email

Text in a mail header area

[Inbound Whitelist (one record is output or an existing record is updated when the sender of received email is regarded as being safe and learned)]

Sender email address (From Address of received email)

Weight calculated with an automatic learning whitelist

Number of times of reception

[Received Email Operation Log (one record is output every time email is answered or forwarded by a mailer)]

Event type (Reply to a sender/Replay to all/Forward)

Whether email subjected to an operation is training email

Message ID of email to be returned or forwarded

Whether email to be answered or forwarded is in ML

Thread position of email to be answered or forwarded

Entry ID of created email (used for retrieving particular email)

Operation date and time

[Outbound Log (one record is output when transmission or cancellation of outbound email is determined)]

Application version number

Policy version number

Number of destination addresses inside an organization

Number of destination addresses outside an organization

Number of file attachments

Violated policy

Action after a policy check

Screen display time

Email identification ID (such as email ID or IP address)

Content of X-Mailer (or User-Agent if X-mailer does not exist)

Entry ID

Outlook process ID

Outlook window handle

Subject presence or absence check result

Attachment presence or absence check result

Email size

Number of characters of email text

File attachment confirmation operation

Number of addresses of initial transmission

Policy check start time

Policy check end time

[Outbound Whitelist (one record is output or an existing record is updated when a destination address is regarded as being safe and learned)]

Transmission destination email address

Weight calculated with an automatic learning whitelist

Number of times of transmission

[Destination Address Log (when doing a policy check on received email or email to be transmitted. No output when canceling transmission)]

From Address (the address of a transmitter in the case of received email, and the own address in the case of email to be transmitted)

Reception/transmission type

Message ID of corresponding email in the case of reception or the entry ID of email to be transmitted in the case of transmission

BCC specified address (delimited by a comma in the case of specifying multiple addresses)

CC specified address (delimited by a comma in the case of specifying multiple addresses)

TCC specified address (delimited by a comma in the case of specifying multiple addresses)

[Training Email Log (one record is output every time an operation is performed on training email)]

Substance of an operation on email (policy check/reply/reply to all/forward)

Type of an item subjected to an operation (a file attachment or a URL link)

Name of an item subjected to an operation

Outputting the GUID portion of the URL character string of the name of an item to be subjected to an operation

Message ID of training email (an ID is generated when creating a message)

[Meeting/Schedule Log (output with respect to information up to the day before that has not been acquired, when staring Outlook)]

Meeting/Schedule type

Whether it is a meeting request or about a meeting to host, and whether it is a meeting request that has been received

Email address of the host (transmitter) of a meeting request

Outputting the comma-delimited email address of a mandatory participant

Outputting the comma-delimited email address of an optional participant

Outputting the comma-delimited email address of the resource of a meeting request

Outputting the comma-delimited email address of the meeting room of a meeting request

Outputting whether a meeting location is inside or outside an organization (determined by the email address of a meeting room)

Start time of a meeting request

End time of a meeting request

Whether it is scheduled for all day

Outputting the alarm of a meeting request

Outputting the importance of a meeting request

Outputting whether a meeting request is private

Information acquired from the web browser 11z includes the following:

[Web Page Reference Log (one record is output at the completion of page loading when referring to a web page)]

View/View Cancellation flag (view cancellation is when the cancellation of access is selected on a display confirmation screen displayed by an FCA add-in)

View/Cancellation reason (view authorization/cancellation by a user, a domain included in a whitelist, a domain that has been learned, an operation other than from Outlook, a URL not contained in the content of email, or a URL in training email)

Internet Explorer (IE) process ID

Domain name of the URL of a website

Character string of the page title of a viewed website

URL of a website

Information acquired from other applications includes the following:

[Office Operation Log (when detecting a major event during operations of the Office applications (Word, Excel, and PowerPoint))

Operated application name (Word, Excel, or PowerPoint)

Name of an opened file

Name of the file path of an opened file

Operation type (an event name such as Open, NewCreate, Save, or Close).

User operation information acquired from, for example, the OS includes the following:

[Key Operation Physical Log (one record is output at each occurrence of a key event)]

Sequence number of an active application when performing a key operation

Process ID

Window handle of an active window

Event type (KD for KeyDown and KU for KeyUp)

Virtual key code (hexadecimal)

[Key Operation Logic Log (one record is output with operations from KeyDown to KeyUp grouped together)]

Sequence number of an active application when performing a key operation

Process ID

Window handle of an active window

Special input (a shortcut operation such as Ctrl+C)

Virtual key code (hexadecimal)

Number of times a key is repeated

Whether a Ctrl key is being depressed

Whether a Shift key is being depressed

Whether an Alt key is being depressed

Whether a Windows key is being depressed

Time elapsed from the start of key inputting to the determination of key inputting

Time from the state where all keys are untouched to the start of initial key inputting (=no-input time)

[Mouse Operation Log (one record is output at each occurrence of a mouse event)]

Sequence number of an active application when operating a mouse

Process ID

Window handle of an active window

Event type (pressing/releasing of each of left, right, center, and other buttons, a wheel operation, or a mouse movement)

Control name at the time of clicking a mouse

Text set in a control at the time of clicking a mouse

X coordinate of a mouse cursor at the occurrence of an event (a screen coordinate system) coordinate of a mouse cursor at the occurrence of an event (a screen coordinate system)

Upper left X coordinate of a clicked control (a screen coordinate system)

Upper left Y coordinate of a clicked control (a screen coordinate system)

Width of a clicked control

Height of a clicked control

Distance between coordinates at which the previous event occurred and current coordinates

Time from the previous event to a current event

[File Operation Log (one record is output with respect to a specified file event or extension)]

Application that has detected a file operation (Explorer/Outlook/HDD monitoring)

Filename of an operated and detected file

Path name of an operated and detected file

Substance of a file operation (file selection by Explorer/email attachment by Outlook/file creation or renaming by HDD monitoring)

System information acquired from, for example, the OS includes the following:

[System Information Log (one file is generated after passage of a prescribed time since activation)]

### [System Basic Information]

Host name

OS name

OS version

OS installation date and time

OS activation date and time

Type of an nth CPU

Maximum clock number of an nth CPU

Size of the second level cache of an nth CPU

Number of CPUs

Whether the OS is 32-bit or 64-bit

Previous OS shutdown date and time

Time required for system activation

Total physical memory size

Available physical memory size

Total virtual memory size

Available virtual memory size

UAC enabled state

### [User Information]

Hash value for a user email address

User position (title) code

Name of a user's department

### [Mouse Settings Information]

Mouse movement speed setting value (prescribed value=10 on a scale of 1 (slowest) to 20 (fastest))

Number of lines scrolled per tick of the vertical scroll wheel of a mouse

Whether a mouse with a wheel function is used or not

Whether the left and right buttons of a mouse are interchanged

### [Display Information]

Number of monitors connected

Resolution (width) of an nth monitor

Resolution (height) of an nth monitor

### [Drive Information]

Number of drives connected

Drive type of an nth drive (optical disk/fixed disk/network drive/removal drive)

Total size of an nth drive

Available space size of an nth drive

### [Taskbar Information]

Number of taskbars registered

Registered position of a taskbar (top, bottom, left, or right)

Presence or absence of a setting to automatically hide a taskbar

Icon size of a taskbar

[Special Folder Information (such as a desktop, a start menu, and a download folder)]

Maximum number of hierarchical folder levels of an XXXXX folder

Number of items of the first hierarchical level of an XXXXX folder (summing up the files (shortcuts and entities) of the folder)

Number of shortcuts of the first hierarchical level of an XXXXX folder (the number of shortcut files)

Number of files of the first hierarchical level of an XXXXX folder (the number of file entities)

Number of folders of the first hierarchical level of an XXXXX folder (the number of folder entities)

Number of items of all the hierarchical levels of an XXXXX folder (summing up the files (shortcuts and entities) of the folder)

Number of shortcuts of all the hierarchical levels of an XXXXX folder (the number of shortcut files)

Number of files of all the hierarchical levels of an XXXXX folder (the number of file entities)

Number of folders of all the hierarchical levels of an XXXXX folder (the number of folder entities)

### [Trash Information]

Number of items in a trash (the number of files+the number of folders)

Total size of items in a trash (the number of files+the number of folders)

### [Windows Update Information]

Critical update check settings

New update installation schedule (every day/specific day only)

New update detection date and time

Date and time of when the downloading of a new update is completed and the new update is ready to be installed

Date and time of when a new update is automatically downloaded and the downloading is completed

Date and time of the completion of installation of a new update

Time (the number of seconds) of suspension of the application of a new update

### [AntiVirus Settings (Symantec Endpoint Protection)]

Whether to automatically update LiveUpdate

Update frequency [Process Information]

Nth process ID

Nth process name

Full path of an nth process (*output only when available)

Module version of an nth process (*output only when available)

Number of processes

### [Application Information]

Name of an nth installed application

Publisher of an nth installed application (*output only when available)

Version of an nth installed application (*output only when available)

Number of applications installed

[Process Status Log (one record is generated at the end of the execution of a process)]

Process ID

Name of the execution module of a process

Execution path of a process (the full path of the execution module excluding the module name)

Process start date and time

Process end date and time

Number of seconds of execution of a process

[Application Status Log (one record is output when changing an active application, a window position, or a window size)]

Sequence number assigned to an active application (for correlation with the logs of a mouse and a keyboard

Process ID

Window handle of an active window (for distinction between different windows in the same process)

Name of the execution module of a process

Execution path of a process (the full path of the execution module excluding the module name)

X coordinate of the position of a window of an application

Y coordinate of the position of a window of an application

Width size of a window of an application

Height size of a window of an application

Number of tabs currently open (only when an active application is IE)

Character string of the window title of an application

Active time of an application

[Network Status Log (output at regular intervals)]

MAC address for a network interface card (NIC)

Number of bytes transmitted since the last log output

Number of bytes received since the last log output

[Performance Log (output at regular intervals)]

CPU usage at the time when a log is output

Usage of each core at the time when a log is output

Maximum use capacity of a memory (physical+virtual)

Amount of use of memory (physical+virtual)

Available capacity of a physical memory

Amount of use of a physical memory

Physical memory usage

Virtual memory capacity

Amount of use of a virtual memory

Virtual memory usage

Number of times paging is performed per second

Average number of write requests in a disk queue

Furthermore, referring to FIG. 2, the terminal 1 includes a cancellation behavior detecting part 15 that detects cancellation behaviors from the information retained in the various logs 14 and the output information of the information acquiring add-ins including the information acquiring add-ins 12x, 12y and 12z and the system information and user operation information acquiring part 13. The detected cancellation behaviors are retained in cancellation behavior logs 16. The cancellation behavior is a behavior of refraining from gaining access with respect to an access target such as a URL or a file attachment, and may be rephrased as an access avoidance behavior. For example, the cancellation behavior is a behavior such as not clicking (selecting) a URL link or the icon of a file attachment while hovering a mouse over the URL link or the icon, canceling an access process before the start of the access process immediately after making a click, suspending or aborting an access process after the start of the access process, and erasing a window after the start of an access process. Here, the access process refers to a process for accessing the access target, starting when an attempt to access is made by selecting the access target and ending when the access is completed, namely, the access is obtained. Furthermore, making email whose text contains a URL link or email with a file attachment active for more than a predetermined time without a click with respect to the URL link or the file attachment may be considered as a cancellation behavior even without a mouseover. These behaviors are recorded as cancellation behaviors although not recorded as actual access.

Behaviors such as noticing that access has been inadvertently obtained or should not be obtained before a page is opened or a file is decompressed and immediately suspending or aborting a subsequent process carry more weight than access behaviors, and are accumulated and analyzed to serve as more useful information. Therefore, such cancellation information is meticulously collected to be utilized to eliminate other concerned parties' access or careless mistakes. A function capable of making a determination using such others' cancellation information is desired to address careless mistakes or sophisticated targeted attacks.

According to most of the conventional techniques, what is actually done to prove useful is recorded for guidance or information sharing. It is common to seek for useful information or contents, and such information alone is abundant. Thus, information on what has not been done carries weight to narrow down the usefulness of information to users.

Furthermore, the cancellation behavior detecting part 15 detects and gathers not only cancellation behaviors in a narrow sense but also information such as normal access status and immediately preceding behaviors to calculate users' operations leading to cancellation behaviors and a proportion to the normal number of accesses. This makes it possible to meticulously gather behavior information including know-how for access that is not obtained, which has not been acquired by the conventional reputation.

Referring to FIG. 2, the server 3 includes an information acquiring part 31 and a cancellation behavior analyzing part 32. The information acquiring part 31 acquires information from the cancellation behavior logs 16 of the terminal 1 (multiple terminals) at predetermined times. The cancellation behavior analyzing part 32 analyzes cancellation behaviors based on the acquired information. The details of the analysis are described below. The results of the analysis are retained in a cancellation behavior characteristics database (DB) 33 as cancellation behavior characteristics.

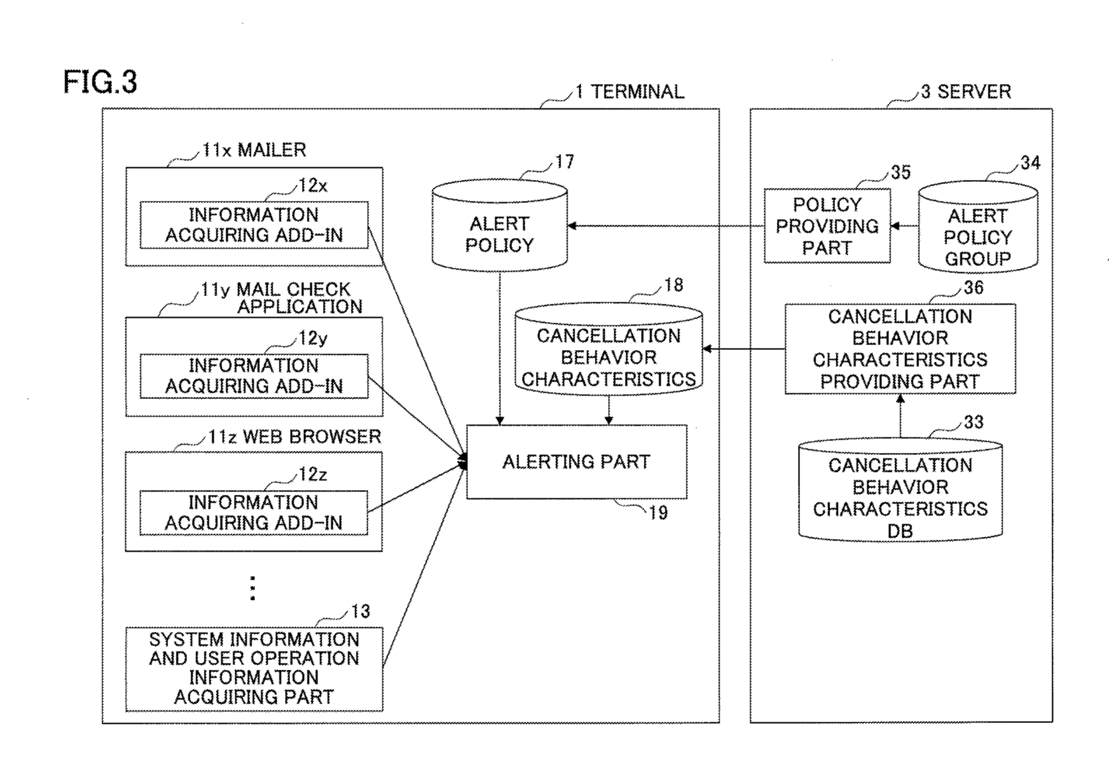

FIG. 3 is a diagram depicting a functional configuration pertaining to provision of information. Referring to FIG. 3, the server 3 includes an alert policy group 34 and a policy providing part 35. The policy providing part 35 acquires an alert policy matching the policy level of the terminal 1 from among multiple types of alert policies corresponding to policy levels in the alert policy group 34, and provides the acquired alert policy. The policy level of the terminal 1 is automatically determined in accordance with the environment or circumstances of a user who uses the terminal 1 or is selected by a user. The provided alert policy is retained in the terminal 1 as an alert policy 17.

Furthermore, the server 3 includes a cancellation behavior characteristics providing part 36 that provides the terminal 1 with the contents of the cancellation behavior characteristics DB 33. The provided cancellation behavior characteristics are retained in the terminal 1 as cancellation behavior characteristics 18. The cancellation behavior characteristics providing part 36 can effectively provide information on a new access target by providing the terminal 1 with the changed or updated contents of the cancellation behavior characteristics DB 33 in real time or at an early point.

The terminal 1 includes an alerting part 19. The alerting part 19 monitors user operations based on information acquired from the information acquiring add-ins including the information acquiring add-ins 12x, 12y and 12z and the system information and user operation information acquiring part 13, and performs alerting in response to determining that a condition for issuing an alert calling for attention is satisfied, using the alert policy 17 and the cancellation behavior characteristics 18.

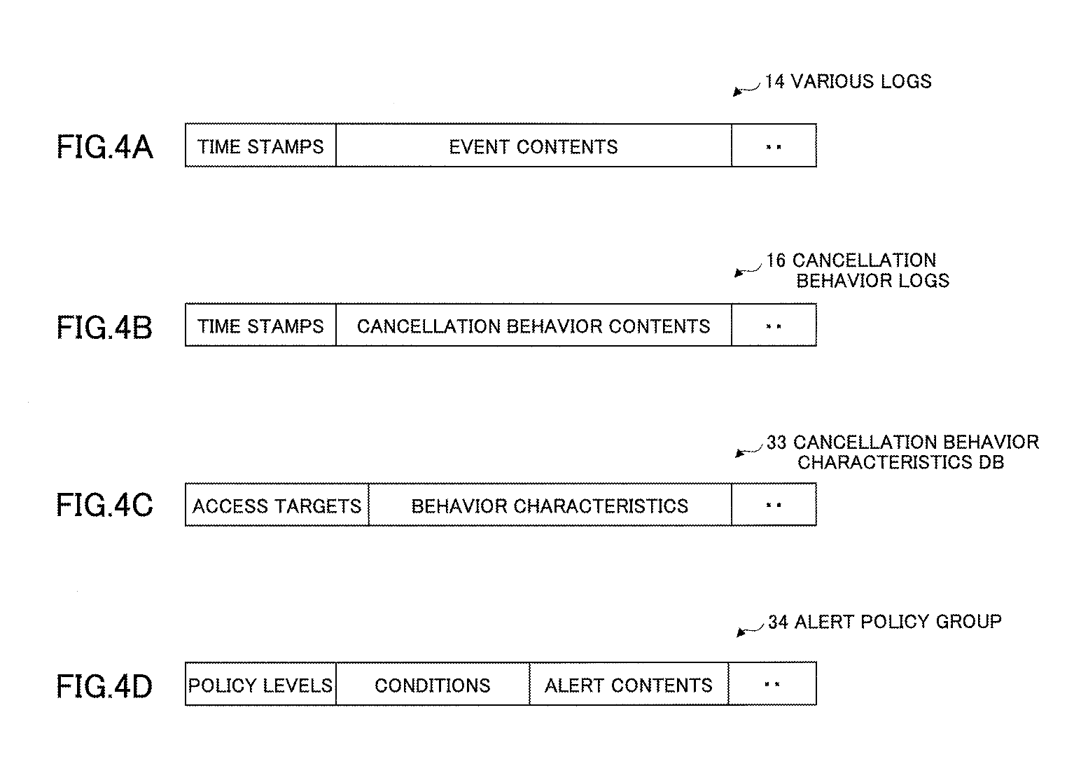

FIGS. 4A through 4D are diagrams depicting various types of information. Referring to FIG. 4A, the various logs 14 include time stamps and the contents of events. Referring to FIG. 4B, the cancellation behavior logs 16 include time stamps and the contents of cancellation behaviors. The contents of cancellation behaviors include, for example, URL information, domains, and the contents of cancellation behaviors such as a cancellation immediately after a click and a mouseover of 1 s (a continuation of a mouseover for one second). Referring to FIG. 4C, the cancellation behavior characteristics DB 33 includes access targets and behavior characteristics. The behavior characteristics include, for example, the number of cancellations, a cancellation rate (the ratio of the number of cancellations to the total of the number of cancellations and the number of accesses), the number of accesses, and an access rate (the ratio of the number of accesses to the total of the number of cancellations and the number of accesses) with respect to each access target (a URL link, a file attachment, or the like) and each user (a user in person, a concerned party inside an organization, or the like). Referring to FIG. 4D, the alert policy group 34 includes policy levels, conditions, and the contents of alerts.

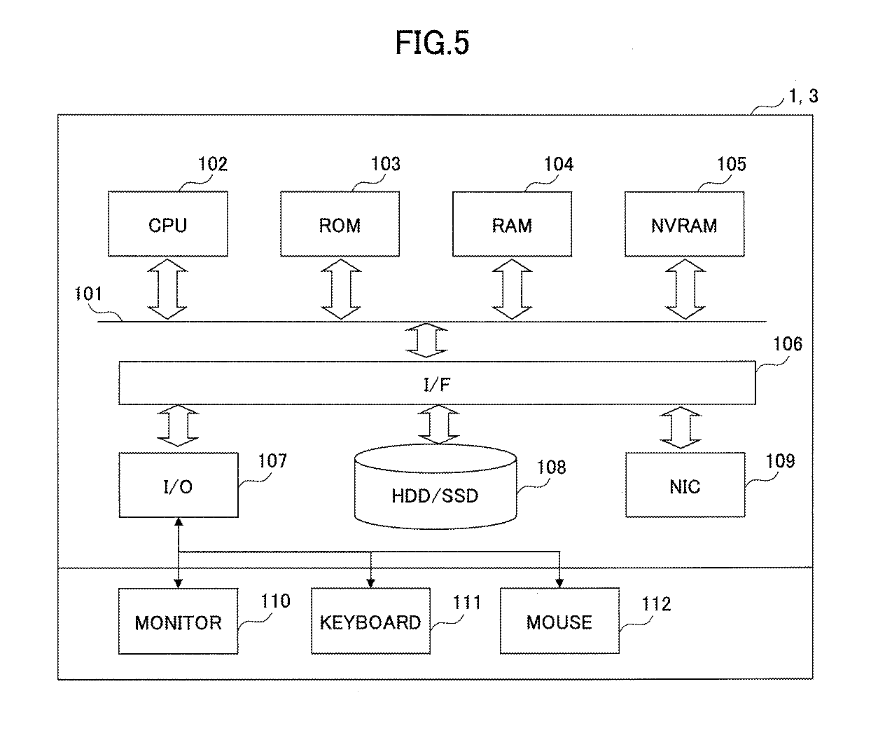

FIG. 5 is a diagram depicting a hardware configuration of the terminal 1 and the server 3. Referring to FIG. 5, each of the terminal 1 and the server 3 includes a central processing unit (CPU) 102, a read-only memory (ROM) 103, a random access memory (RAM) 104, and a non-volatile RAM (NVRAM) 105, all of which are connected to a system bus 101. Each of the terminal 1 and the server 3 further includes an interface (I/F) 106, and further includes an input/output (I/O) device 107, a hard disk drive (HDD) or solid state drive (SSD) (HDD/SDD) 108, and a network interface card (NIC) 109, all of which are connected to the I/F 106. Each of the terminal 1 and the server 3 further includes a monitor 110, a keyboard 111, and a mouse 112, all of which are connected to the I/O device 107. A compact disk (CD) and digital versatile disk (DVD) drive may be connected to the I/O device 107.

The functions of the terminal 1 and the server 3 described with reference to FIGS. 2 and 3 may be implemented by the CPU 102 executing a predetermined program stored in a memory in the terminal 1 and the server 3. The program may be obtained by way of a recording medium or an electrical network. The program may also be incorporated in the ROM 103.

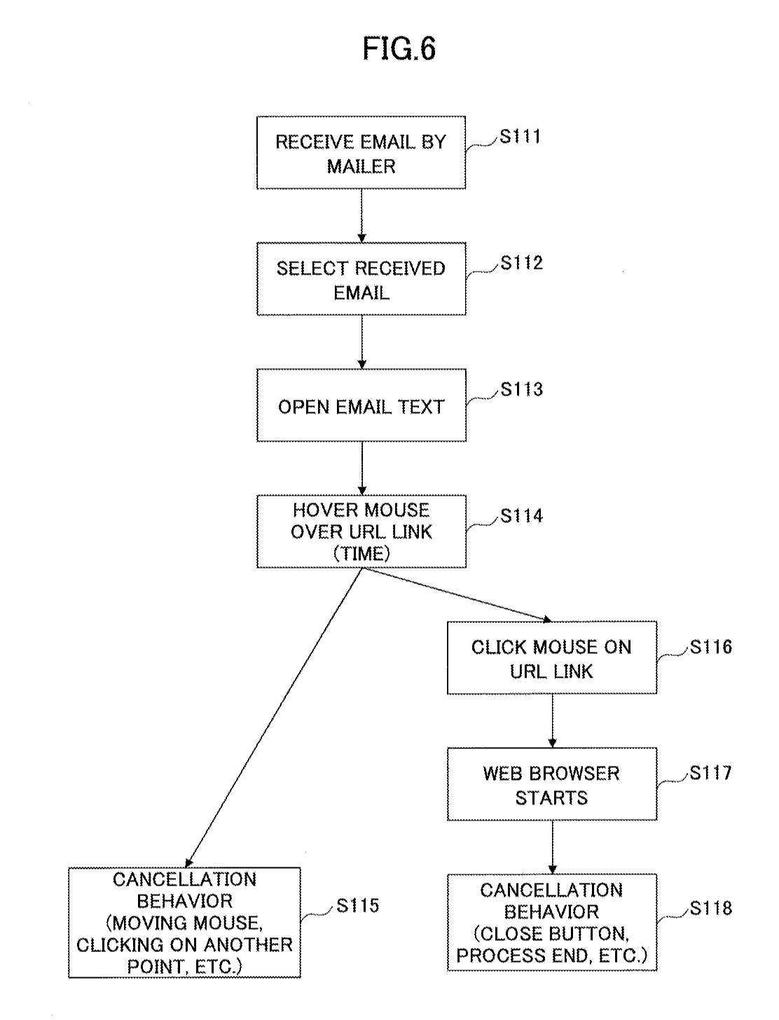

FIG. 6 is a flowchart illustrating an example of the detection of a cancellation behavior by the cancellation behavior detecting part 15 of the terminal 1. FIG. 6 illustrates the case where a cancellation behavior is executed after hovering a mouse over a URL link embedded in the text of received email.

Referring to FIG. 6, at step S111, the mailer 11x receives email. At step S112, a user selects the received email. At step S113, the user opens the email text. At step S114, the user hovers a mouse over the URL link. Thereafter, at step S115, a cancellation behavior is detected in response to proceeding to another operation, such as moving the mouse or clicking on another point, without clicking the mouse, and is recorded in the cancellation behavior logs 16.

On the other hand, at step S116, the mouse is clicked on the URL link after being hovered over the URL link at step S115, and at step S117, the web browser 11z is started. In this case, at step S118, a cancellation behavior is detected in response to a CLOSE button being operated or a process being ended (such as the closure of a window), and is recorded in the cancellation behavior logs 16.

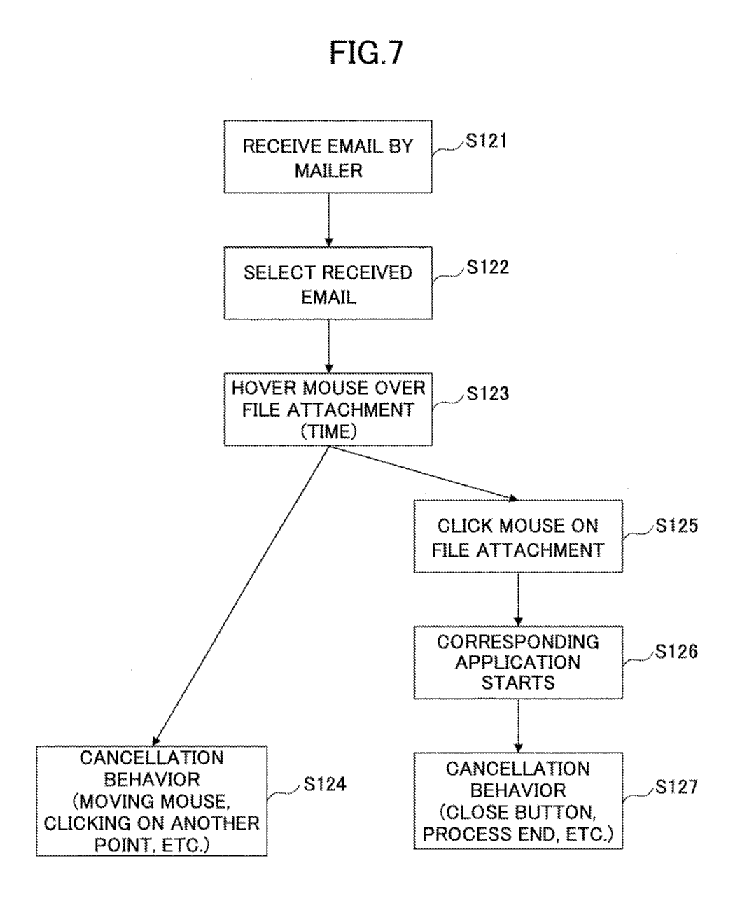

FIG. 7 is a flowchart illustrating another example of the detection of a cancellation behavior by the cancellation behavior detecting part 15 of the terminal 1. FIG. 7 illustrates the case where a cancellation behavior is executed after hovering a mouse over a file attachment of received email.

Referring to FIG. 7, at step S121, the mailer 11x receives email. At step S122, a user selects the received email. At step S123, the user hovers a mouse over the icon of a file attachment of the email. Thereafter, at step S124, a cancellation behavior is detected in response to proceeding to another operation, such as moving the mouse or clicking on another point, without clicking the mouse, and is recorded in the cancellation behavior logs 16.

On the other hand, at step S125, the mouse is clicked on the icon of the file attachment after being hovered over the icon at step S124, and at step S126, a corresponding application (such as word processing application, a spreadsheet application, or a presentation application) is started. In this case, at step S127, a cancellation behavior is detected in response to a CLOSE button being operated or a process being ended (such as the closure of a window), and is recorded in the cancellation behavior logs 16.

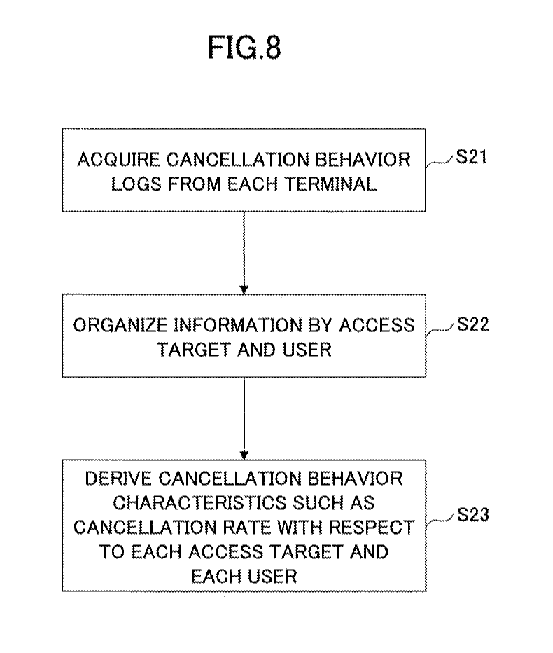

FIG. 8 is a flowchart illustrating a process of analyzing a cancellation behavior by the server 3. Referring to FIG. 8, at step S21, the information acquiring part 31 of the server 3 acquires the cancellation behavior logs 16 from each terminal 1.

Next, at step S22, the cancellation behavior analyzing part 32 organizes (sorts) information by access target (a URL link, a file attachment, or the like) and user (a user in person, a concerned party inside an organization, or the like).

Next, at step S23, the cancellation behavior analyzing part 32 derives cancellation behavior characteristics such as the number of cancellations, a cancellation rate (the ratio of the number of cancellations to the total of the number of cancellations and the number of accesses), the number of accesses, and an access rate (the ratio of the number of accesses to the total of the number of cancellations and the number of accesses) with respect to each access target and each user. The derived cancellation behavior characteristics are retained in the cancellation behavior characteristics DB 33, and are provided to the terminal 1 by the cancellation behavior characteristics providing part 36 as the cancellation behavior characteristics 18.

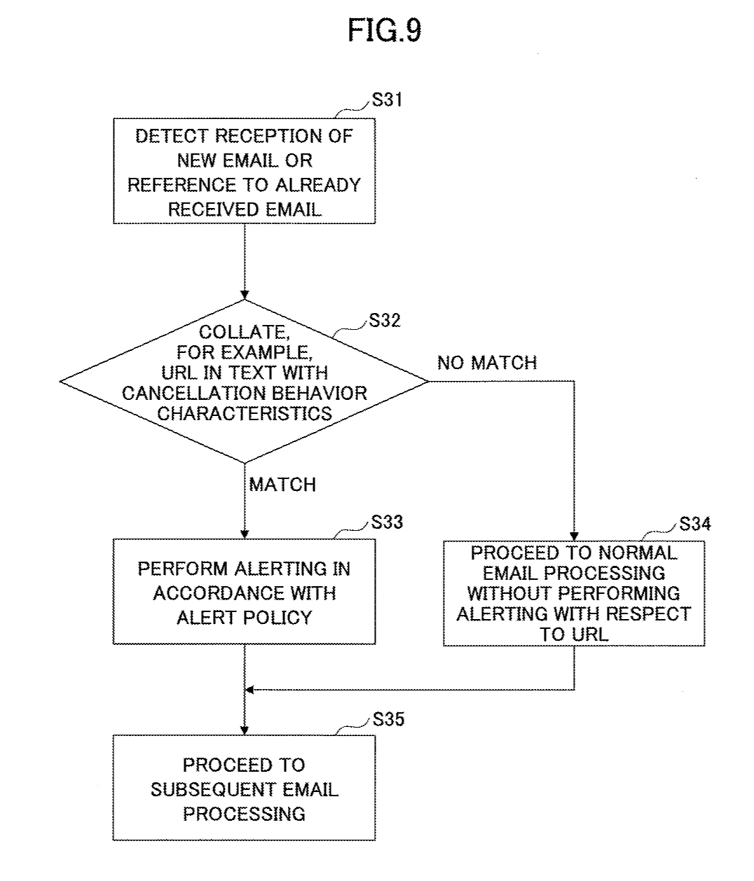

FIG. 9 is a flowchart illustrating a process of alerting by the alerting part 19 of the terminal 1. Referring to FIG. 9, at step S31, the alerting part 19 detects reception of new email or reference to already received email based on information acquired from the information acquiring add-ins including the information acquiring add-ins 12x, 12y and 12z and the system information and user operation information acquiring part 13. At step S32, the alerting part 19 collates an access target such as a URL link included in the text or a file attachment with the cancellation behavior characteristics 18.

At step S33, if the results of the collation include a match, the alerting part 19 performs alerting with respect to the access target such as a URL link or a file attachment in accordance with the alert policy 17.

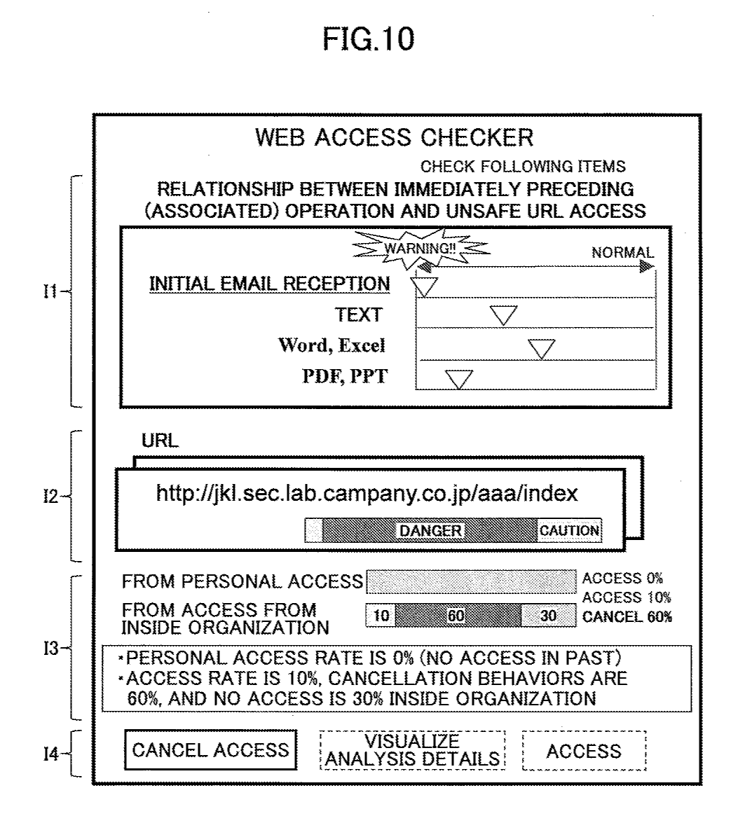

FIG. 10 is a diagram illustrating an example of alerting. Display I1 displays RELATIONSHIP BETWEEN IMMEDIATELY PRECEDING (ASSOCIATED) OPERATION AND UNSAFE URL ACCESS, indicating the relationship between operations and risk based on actual values or general statistical values. In the illustrated case, INITIAL EMAIL RECEPTION is indicated as the immediately preceding operation by being emphasized by, for example, underlining. Display I2 displays the degree of DANGER and the degree of CAUTION with respect to multiple URLs included in the text of, for example, email. Display I3 displays the proportion of access and the proportion of access cancellation (cancellation behaviors) using a graph and a character string with respect to personal access and access from inside an organization. Display I4 displays buttons such as an ACCESS CANCELLATION button.

Referring back to FIG. 9, if the results of the collation include no match at step S32, at step S34, the alerting part 19 does not perform alerting with respect to the access target such as a URL link or a file attachment, and proceeds to normal email processing. Thereafter, in either case, at step S35, the alerting part 19 proceeds to subsequent email processing.

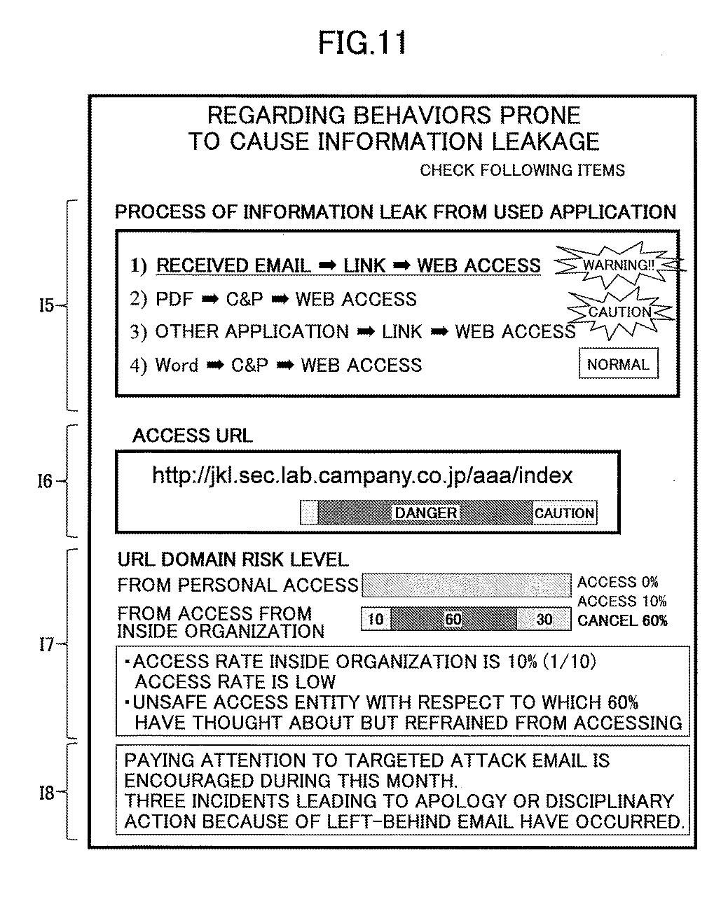

While the above description is given of the case of performing alerting based on the monitoring of user operations, it is also possible to display information in light of information sharing or provision at a user's request (security check request). FIG. 11 is a diagram illustrating provision of information. Display I5 displays PROCESS OF INFORMATION LEAK FROM USED APPLICATION, indicating the relationship between used applications and risk based on actual values or general statistical values. In the illustrated case, RECEIVED EMAIL→LINK→WEB ACCESS is indicated as the immediately preceding operation by being emphasized by, for example, underlining. Display I6 displays the degree of DANGER and the degree of CAUTION with respect to multiple URLs included in the text of, for example, email. Display I7 displays the proportion of access and the proportion of access cancellation (cancellation behaviors) using a graph and a character string with respect to personal access and access from inside an organization. Display I8 displays a message with respect to network security.

The above-described techniques may be applied to not only web access but also, for example, the behaviors of multiple users such as not making a selection in response to guidance based on tendency information in a car navigation system and refraining from purchasing or stopping purchase immediately before the purchase is completed in merchandise purchase. Such information may be provided not from the standpoint of a provider but as information useful for making a determination on the user side. In this case as well, it is possible for a user to make a determination while taking the circumstances around the user into consideration, and thus to reduce mistakes in selection.

As described above, according to this embodiment, information useful for making a determination is provided when an attempt is made to access a URL or a file attachment. Therefore, at the time of access, a user can easily make a determination, and accordingly, reduce careless mistakes. Accordingly, it is possible to improve network security.

All examples and conditional language provided herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority or inferiority of the invention. Although one or more embodiments of the present invention have been described in detail, it should be understood that the various changes, substitutions, and alterations could be made hereto without departing from the spirit and scope of the invention.

What is claimed is:

1. A safety determining apparatus, comprising:
a memory; and
a processor coupled to the memory,
and configured to
acquire information on a user operation and an access target of the user operation;
acquire information indicating a behavior of refraining from gaining access with respect to the access target by analyzing the user operation; and
provide a user with information on safety of the access target with respect to which the behavior has been executed.

2. The safety determining apparatus as claimed in claim 1, wherein the processor is further configured to determine that the behavior of refraining from gaining the access has been executed with respect to a URL link that is the access target when a behavior of avoiding the access is executed after a mouse is hovered over the URL link or when a behavior of suspending or aborting the access is executed after the mouse is clicked on the URL link.

3. The safety determining apparatus as claimed in claim 1, wherein the processor is further configured to determine that the behavior of refraining from gaining the access has been executed with respect to a file attachment that is the access target when a behavior of avoiding the access is executed after a mouse is hovered over an icon of the file attachment or when a behavior of suspending or aborting the access is executed after the mouse is clicked on the icon of the file attachment.

4. The safety determining apparatus as claimed in claim 1, wherein the processor is further configured to provide the user with the information on the safety of the access target in accordance with a condition specified by an alert policy and a content of an alert.

5. A non-transitory computer-readable recording medium storing a program that causes a computer to execute a safety determining process, the safety determining process comprising:
acquiring information on a user operation and an access target of the user operation;
acquiring information indicating a behavior of refraining from gaining access with respect to the access target by analyzing the user operation; and
providing a user with information on safety of the access target with respect to which the behavior has been executed.

6. The non-transitory computer-readable recording medium as claimed in claim 5, wherein the safety determining process further includes determining that the behavior of refraining from gaining the access has been executed with respect to a URL link that is the access target when a behavior of avoiding the access is executed after a mouse is hovered over the URL link or when a behavior of suspending or aborting the access is executed after the mouse is clicked on the URL link.

7. The non-transitory computer-readable recording medium as claimed in claim 5, wherein the safety determining process further includes determining that the behavior of refraining from gaining the access has been executed with respect to a file attachment that is the access target when a behavior of avoiding the access is executed after a mouse is hovered over an icon of the file attachment or when a behavior of suspending or aborting the access is executed after the mouse is clicked on the icon of the file attachment.

8. The non-transitory computer-readable recording medium as claimed in claim 5, wherein the providing provides the user with the information on the safety of the access target in accordance with a condition specified by an alert policy and a content of an alert.

9. A safety determining method, comprising:
acquiring, by a computer processor, information on a user operation and an access target of the user operation;
acquiring, by the computer processor, information indicating a behavior of refraining from gaining access with respect to the access target by analyzing, by the computer processor, the user operation; and
providing, by the computer processor, a user with information on safety of the access target with respect to which the behavior has been executed.

10. The safety determining method as claimed in claim 9, further comprising:
determining, by the computer processor, that the behavior of refraining from gaining the access has been executed with respect to a URL link that is the access target when a behavior of avoiding the access is executed after a mouse is hovered over the URL link or when a behavior of suspending or aborting the access is executed after the mouse is clicked on the URL link.

11. The safety determining method as claimed in claim 9, further comprising:
determining, by the computer processor, process includes determining that the behavior of refraining from gaining the access has been executed with respect to a file attachment that is the access target when a behavior of avoiding the access is executed after a mouse is hovered over an icon of the file attachment or when a behavior of suspending or aborting the access is executed after the mouse is clicked on the icon of the file attachment.

12. The safety determining method as claimed in claim 9, wherein the providing provides the user with the information on the safety of the access target in accordance with a condition specified by an alert policy and a content of an alert.
